(19) United States
(12) Patent Application Publication
(10) Pub. No.: US 2011/0216312 A1
(43) Pub. Date: Sep. 8, 2011

(54) SEMICONDUCTOR INSPECTION DEVICE AND INSPECTION METHOD

(75) Inventors: Toru Matsumoto, Shizuoka (JP); Yoshimitsu Aoki, Shizuoka (JP); Masayoshi Tonouchi, Osaka (JP); Hironaru Murakami, Osaka (JP); Sunmi Kim, Osaka (JP); Masatsugu Yamashita, Saitama (JP); Chiko Otani, Saitama (JP)

(73) Assignees: HAMAMATSU PHOTONICS K.K., Hamamatsu-shi (JP); OSAKA UNIVERSITY, Osaka (JP); RIKEN, Saitama (JP)

(21) Appl. No.: 13/061,363

(22) PCT Filed: Aug. 27, 2009
(86) PCT No.: PCT/JP2009/064946

§ 371 Date: May 13, 2011

(30) Foreign Application Priority Data
Sep. 1, 2008 (JP) 2008-223612

(51) Int. Cl. G01N 21/00

(52) U.S. Cl. 356/237.1

(57) ABSTRACT

For a semiconductor device S, an inspection is performed in a zero-bias state by use of electromagnetic waves generated by irradiation of pulsed laser light, and an inspection range is set with reference to layout information of the semiconductor device S to perform two-dimensional scanning by inspection light L1 of the pulsed laser light within the range. Moreover, with the inspection range of the semiconductor device S arranged at a predetermined position with respect to an optical axis of an optical system, and with a solid immersion lens 36 disposed for the semiconductor device S, by a galvanometer scanner 30 being scanning means, the inspection range of the semiconductor device S is two-dimensionally scanned by the inspection light L1 via the solid immersion lens 36, and an electromagnetic wave emitted from the semiconductor device S is detected by a photoconductive element 40. Accordingly, a semiconductor inspection apparatus and inspection method capable of preferably performing an inspection in a zero-bias state for a semiconductor device is realized.

### TECHNICAL FIELD

The present invention relates to a semiconductor inspection apparatus and semiconductor inspection method that performs an inspection in a zero-bias state for a semiconductor device.

### BACKGROUND ART

As a method for performing an inspection, such as a failure diagnosis, in a zero-bias state for a semiconductor device, a method disclosed in Patent Document 1 has been known. In this inspection method, the semiconductor device of an inspection object is two-dimensionally scanned while being irradiated with pulsed laser light. Then, by detecting electromagnetic waves such as terahertz waves emitted from the position irradiated with the laser light, information regarding the existence of a failure and the like in the semiconductor device is obtained (refer to Patent Document 1, and Non Patent Documents 1 and 2).

### CITATION LIST

### Patent Literature

Patent Document 1: Japanese Patent Application Laid-Open No. 2006-24774

### Non Patent Literature

Non Patent Document 1: M. Yamashita et al., “THz emission characteristics from LSI-TEG chips under zero bias voltage,” Proceedings of Join 32nd International Conference on Infrared and Millimetre Waves, and 15th International Conference on Terahertz Electronics (IRMMW-THz 2007), pp. 279-280
Non Patent Document 2: M. Yamashita et al., “Noncontact inspection technique for electrical failures in semiconductor devices using a laser terahertz emission microscope,” Applied Physics Letters Vol. 93, pp. 041117-1-3 (2008)

### SUMMARY OF INVENTION

### Technical Problem

By the method for performing inspection in a zero-bias state as described above, it is possible to inspect a semiconductor device in a non-contact manner, and it is possible to, for example, conduct inspection in the middle of a manufacturing process of a semiconductor device. However, in the configuration described in Patent Document 1, since a position resolution is determined according to the spot size of pulsed laser light with which the semiconductor device is irradiated as inspection light, there is a problem that the resolution of a semiconductor inspection is limited by the performance of an objective lens and the like.

Moreover, in Patent Document 1, used is a configuration, with a stage for an inspection that holds a semiconductor device used as a scanning table, for two-dimensionally moving the semiconductor device to perform scanning. In such a configuration, when the semiconductor device as a whole is two-dimensionally scanned with inspection light, there is a problem such that the measuring time required for that inspection processing is lengthened. Moreover, there is also a description of two-dimensional scanning using an oscillating minor, but a specific configuration thereof has not been discussed.

The present invention has been made to solve the above problems, and an object thereof is to provide a semiconductor inspection apparatus and semiconductor inspection method capable of suitably performing an inspection in a zero-bias state for a semiconductor device.

### Solution to Problem

In order to achieve such an object, a semiconductor inspection apparatus according to the present invention comprises: (1) an inspection stage holding a semiconductor device in a zero-bias state to be an inspection object; (2) a laser light source irradiating the semiconductor device with pulsed laser light as inspection light; (3) an inspection light guide optical system guiding the inspection light from the laser light source to the semiconductor device, and including scanning means that controls an optical path of the inspection light for two-dimensionally scanning by the inspection light within an inspection range set for the semiconductor device; (4) a solid immersion lens, disposed between the semiconductor device and the inspection light guide optical system, and condensing the inspection light while irradiating the semiconductor device with the inspection light from the inspection light guide optical system; (5) electromagnetic wave detection means detecting an electromagnetic wave generated in the semiconductor device by irradiation of the inspection light, and emitted via the solid immersion lens; and (6) inspection control means controlling inspection of the semiconductor device, and the inspection control means includes inspection range setting means setting, for the semiconductor device, with reference to layout information thereof, the inspection range that needs to be two-dimensionally scanned by the inspection light via the solid immersion lens; position control means controlling, with reference to the layout information of the semiconductor device, a position of the semiconductor device with respect to the inspection light guide optical system to arrange the inspection range at a predetermined position with respect to an optical axis; and scanning control means controlling driving of the scanning means to control two-dimensional scanning by the inspection light via the solid immersion lens within the inspection range of the semiconductor device.

Moreover, a semiconductor inspection method according to the present invention uses a semiconductor inspection apparatus including: (1) an inspection stage holding a semiconductor device in a zero-bias state to be an inspection object; (2) a laser light source irradiating the semiconductor device with pulsed laser light as inspection light; (3) an inspection light guide optical system guiding the inspection light from the laser light source to the semiconductor device, and including scanning means that controls an optical path of the inspection light for two-dimensionally scanning by the inspection light within an inspection range set for the semiconductor device; (4) a solid immersion lens, disposed between the semiconductor device and the inspection light guide optical system, and condensing the inspection light while irradiating the semiconductor device with the inspection light from the inspection light guide optical system; and (5) electromagnetic wave detection means detecting an electromagnetic wave generated in the semiconductor device by irradiation of the inspection light, and emitted via the solid immersion lens, and the semiconductor inspection method comprises: (6) an inspection range setting step of setting, for the semiconductor device, with reference to layout information thereof, the inspection range that needs to be two-dimensionally scanned by the inspection light via the solid immersion lens; a position control step of controlling, with reference to the layout information of the semiconductor device, a position of the semiconductor device with respect to the inspection light guide optical system to arrange the inspection range at a predetermined position with respect to an optical axis; and a scanning control step of controlling driving of the scanning means to control two-dimensional scanning by the inspection light via the solid immersion lens within the inspection range of the semiconductor device.

In the semiconductor inspection apparatus and inspection method described above, inspection is performed for the semiconductor device being an inspection object in a zero-bias state by use of an electromagnetic wave such as a terahertz wave generated by irradiation of pulsed laser light. Accordingly, as described above, the semiconductor device can be inspected in a non-contact manner. Moreover, in such a non-contact inspection, the semiconductor device as a whole is not two-dimensionally scanned with the inspection light, but an inspection range is set with reference to the layout information indicating a configuration of p-n junction portions, wiring, and the like in the semiconductor device, and two-dimensional scanning by the inspection light is performed within the range. Accordingly, the measuring time required for the inspection processing can be reduced.

Moreover, in the above-described configuration, in response to the configuration where an inspection range is set for the semiconductor device, the position of the semiconductor device is controlled with reference to the layout information to arrange the inspection range at a predetermined position (for example, a position on the optical axis) with respect to the optical axis of the optical system. Then, the semiconductor device is fixed with the inspection range disposed at the predetermined position, the solid immersion lens is disposed for the semiconductor device, and by the scanning means provided in the inspection light guide optical system, two-dimensional scanning is performed, via the solid immersion lens, by the inspection light within the inspection range of the semiconductor device. Further, electromagnetic waves such as terahertz waves emitted via the solid immersion lens from the position irradiated with inspection light of the semiconductor device are detected to thereby perform inspection of the semiconductor device.

Thus, by performing inspection with the solid immersion lens disposed on the semiconductor device, irradiation of inspection light and detection of electromagnetic waves can both be improved in position resolution by the solid immersion lens so as to perform inspection in greater detail and accurately in terms of the p-n junction portions, wiring, and the like included in the semiconductor device. Moreover, by fixing the inspection stage holding the semiconductor device so as to provide a configuration that allows performing two-dimensional scanning of the inspection light by the scanning means on the optical system side, application of the solid immersion lens to the semiconductor device and two-dimensional scanning of the semiconductor device by the inspection light can both be suitably realized. By the above, the above-described configuration makes it possible to preferably perform an inspection in a zero-bias state for the semiconductor device.

### ADVANTAGEOUS EFFECTS OF INVENTION

According to the semiconductor inspection apparatus and inspection method of the present invention, inspection is performed, for a semiconductor device, in a zero-bias state by use of electromagnetic waves generated by irradiation of pulsed laser light, and an inspection range is set with reference to layout information of the semiconductor device to perform two-dimensional scanning by inspection light within the range. Moreover, with the inspection range arranged at a predetermined position with respect to the optical axis of an optical system, and with a solid immersion lens disposed with respect to the semiconductor device, by scanning means of the optical system, the semiconductor device is, within the inspection range thereof, two-dimensionally scanned by the inspection light via the solid immersion lens, and electromagnetic waves emitted via the solid immersion lens from the position irradiated with the inspection light are detected. Accordingly, it becomes possible to suitably perform an inspection in a zero-bias state for the semiconductor device.

### BRIEF DESCRIPTION OF DRAWINGS

FIG. 1 is a diagram showing a configuration of an embodiment of a semiconductor inspection apparatus.

FIG. 2 is a block diagram showing an example of a configuration of an inspection control device.

FIG. 3 is a flowchart showing an example of a semiconductor inspection method.

FIG. 4 is a flowchart showing an example of a method for acquiring an inspection image of a non-defective chip.

FIG. 5 is a flowchart showing an example of a method for acquiring an inspection image of an inspection chip.

FIG. 6 includes views showing an example of extraction of inspection candidate parts for a semiconductor device.

FIG. 7 is a view showing an example of alignment of a layout image and a chip image.

FIG. 8 includes views showing an example of alignment of a layout image and a chip image.

FIG. 9 is a view showing another example of alignment of a layout image and a chip image.

FIG. 10 includes views showing an example of setting of an inspection range for a semiconductor device.

FIG. 11 includes views showing another example of setting of an inspection range for a semiconductor device.

FIG. 12 is a view showing another example of setting of an inspection range for a semiconductor device.

FIG. 13 includes views showing setting of a position of a semiconductor device.

FIG. 14 is a graph showing an example of a temporal waveform of a terahertz wave.

FIG. 15 includes views showing two-dimensional scanning of a semiconductor device by inspection light.

FIG. 16 includes views showing an example of a failure analysis method by using a detected intensity of a terahertz wave.

FIG. 17 is a view showing an example of a method for estimating a disconnected point in wiring of a semiconductor device.

### DESCRIPTION OF EMBODIMENTS

Hereinafter, preferred embodiments of a semiconductor inspection apparatus and inspection method according to the present invention will be described in detail along with the drawings. Also, the same components are denoted with the same reference symbols in the drawings, and overlapping description will be omitted. Moreover, dimensional ratios in the drawings do not always coincide with those in the description.

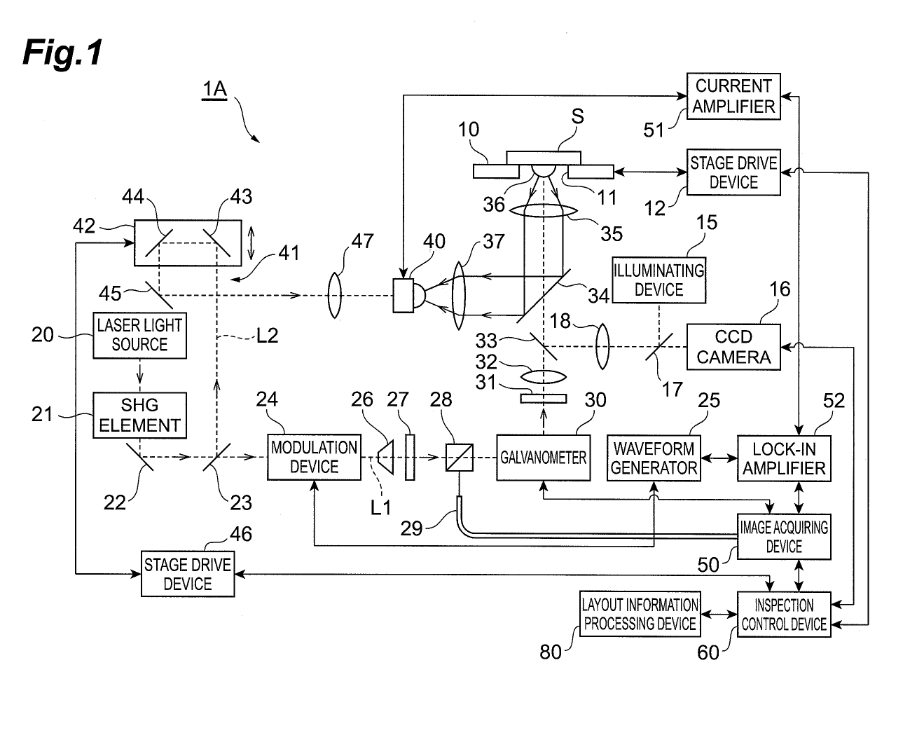

FIG. 1 is a diagram schematically showing a configuration of an embodiment of a semiconductor inspection apparatus according to the present invention. The semiconductor inspection apparatus 1A according to the present embodiment is an inspection apparatus for performing, for a semiconductor device S of an inspection object, inspection in a zero-bias state using an electromagnetic wave such as a terahertz wave (electromagnetic wave of a frequency of, for example, 0.1 THz to 10 THz) generated by irradiation of pulsed laser light, and is configured with an inspection stage 10, a laser light source 20, and a photoconductive element 40. Hereinafter, the configuration of the semiconductor inspection apparatus 1A will be described along with a semiconductor inspection method.

The semiconductor device S is held in a zero-bias state on the inspection stage 10. The semiconductor device S is, with a device surface thereof formed with p-n junction portions, wiring, and the like located at the upside, and a back surface thereof located at the downside, placed on the stage 10. Moreover, in the stage 10, an opening 11 is provided so as to allow observing the semiconductor device S from the downside. The inspection apparatus 1A of the present embodiment is configured so as to perform irradiation of inspection light and detection of electromagnetic waves for the semiconductor device S on the stage 10 from the downside via the opening 11. Moreover, the inspection stage 10 is, for setting and adjusting the position of the semiconductor device S with respect to the optical axis of an inspection light guide optical system, configured so as to be driven by an inspection stage drive device 12.

A pulsed laser light source 20 that supplies pulsed laser light and irradiates the semiconductor device S on the stage 10 with the pulsed laser light as inspection light is provided. As the inspection light, pulsed laser light having an intensity and pulse width suitable for performing a semiconductor inspection using electromagnetic waves such as terahertz waves is used (refer to, for example, Patent Document 1). Specifically, it is preferable to use, as the laser light source 20, a femtosecond pulsed laser light source that supplies femtosecond pulsed laser light. Moreover, in terms of a specific pulse width, it is preferable to use pulsed laser light having a pulse width of, for example, 1 femtosecond (fs) to 10 picoseconds (10 ps).

Moreover, as for the wavelength of inspection light, laser light having a wavelength in the near-infrared region (laser light of a wavelength of, for example, 750 nm to 2500 nm) can be preferably used. Here, it is assumed to use, as an example of the inspection light, laser light of a wavelength of 1059 nm supplied from the femtosecond pulsed laser light source 20. Moreover, an SHG element 21 is arranged at a subsequent stage of the femtosecond laser light source 20, and in the SHG element 21, second harmonic light of a wavelength of 529 nm is generated.

The laser light and second harmonic light from the SHG element 21 are led to a harmonic separator 23 by a reflecting mirror 22, and in the separator 23, separated into inspection light L1 of a wavelength of 1059 nm toward the semiconductor device S and probe light L2 of a wavelength of 529 nm toward the photoconductive element 40 for detecting electromagnetic waves. Moreover, the inspection light L1 from the separator 23 is input to a modulation device 24, and in the modulation device 24, the temporal waveform of the inspection light L1 is modulated based on a modulation waveform of a sine wave, a square wave, or the like generated by a waveform generator 25. Examples of the modulation device 24 that can be used include an AOM, an optical chopper, or the like.

Between the modulation device 24 and the semiconductor device S on the inspection stage 10, an inspection light guide optical system for guiding the inspection light L1 from the laser light source 20 to the semiconductor device S is provided. In the configuration example shown in FIG. 1, the light guide optical system is composed of, in order from the side of the modulation device 24, a beam expander 26, a wave plate 27, a galvanometer scanner 30, a wave plate 31, a lens 32, and an objective lens 35. Between the wave plate 27 and the galvanometer scanner 30, a polarization beam splitter 28 is arranged. Moreover, between the lens 32 and the objective lens 35, a half-mirror 33 and an ITO coated optical plate 34 are arranged.

The inspection light L1 output from the modulation device 24 is spatially expanded by the beam expander 26, passes through the ½λ wave plate 27 and the polarization beam splitter 28, and is input to the galvanometer scanner 30. The galvanometer scanner 30 is scanning means for controlling the optical path of the inspection light L1 for two-dimensionally scanning by the inspection light L1 within an inspection range set for the semiconductor device S. The inspection light L1 is, by this galvanometer scanner 30, scanned in two directions perpendicular to the optical axis while being irradiated onto the semiconductor device S.

Moreover, between the objective lens 35 and the semiconductor device S placed on the inspection stage 10, a solid immersion lens 36 is disposed in a state optically closely fitted to the back surface of the semiconductor device S. The inspection light L1 from the galvanometer scanner 30 reaches the solid immersion lens 36 via the ¼λ wave plate 31, the lens 32, the half-mirror 33, the optical plate 34, and the objective lens 35, and is, by this solid immersion lens 36, condensed while a respective portion such as a p-n junction portion in the semiconductor device S is irradiated with the inspection light. Moreover, as the solid immersion lens 36, a lens that is specifically in, for example, a hemispherical shape or a hyper hemispherical shape is used.

In the semiconductor device S in a zero-bias state irradiated with the pulsed inspection light L1, an electromagnetic wave such as a terahertz wave is generated at a predetermined portion inside thereof. More specifically, within the semiconductor device S, an internal electric field (built-in field) exists at a p-n junction portion, a metal-semiconductor interface, a portion where the carrier density changes, etc.

When such a portion where an internal field exists is irradiated with pulsed laser light having an energy greater than the band gap as the inspection light L1, electron-hole pairs by photo-excitation are generated. Then, these photo-excited carriers are accelerated by the internal field to cause a pulsed current to flow, and an electromagnetic wave is thereby generated. Moreover, this electromagnetic wave, depending on the state of the p-n junction portion being a generation portion, wiring connected to the p-n junction portion, or the like, changes in the electromagnetic wave generating condition such as the intensity thereof. Therefore, detecting such an electromagnetic wave allows obtaining information concerning a failure and the like of the semiconductor device S.

For the electromagnetic wave to be generated by irradiation of the inspection light L1 in the semiconductor device S on the stage 10, the photoconductive element 40 is provided as electromagnetic wave detection means. The electromagnetic wave emitted via the solid immersion lens 36 from the semiconductor device S passes through the objective lens 35, is reflected by the ITO film provided on the optical plate 34, and then focused by a Teflon lens 37 while being made incident onto the photoconductive element 40.

The photoconductive element 40 is being supplied with the probe light L2 that has been separated by the harmonic separator 23. The timing for supplying the probe light L2 to the photoconductive element 40 is, in order to allow detection of the electromagnetic wave generated in the semiconductor device S, set so as to be a predetermined timing with respect to the timing of the inspection light L1 made incident onto the semiconductor device S.

Between the separator 23 and the photoconductive element 40, a probe light guide optical system including a time-delay optical system 41 is provided. The time-delay optical system 41 is configured to have a variable optical path length, and used for setting and changing the timing of the probe light L2 to be made incident onto the photoconductive element 40. In the configuration example shown in FIG. 1, the time-delay optical system 41 is composed of a time-delay stage 42 configured to be movable by a delay stage drive device 46, reflecting mirrors 43, 44 disposed on the stage 42, and a reflecting mirror 45 fixedly disposed separately from the stage 42. The probe light L2 adjusted in timing by the time-delay optical system 41 is condensed via a condenser lens 47 while being made incident onto the photoconductive element 40.

In the photoconductive element 40, photo-excited carriers are generated by irradiation of the probe light L2. Then, when an electromagnetic wave such as a terahertz wave is made incident onto the photoconductive element 40 in this state, as a result of a current due to photo-excited carriers thereby flowing, the electromagnetic wave is detected. Moreover, in such electromagnetic wave detection, by changing the timing of the probe light L2 to be made incident onto the photoconductive element 40, the temporal waveform of the electromagnetic wave can be measured.

A detection signal output from the photoconductive element 40 is amplified by a current amplifier 51 to be converted to a voltage signal, and is then input to an image acquiring device 50 by way of a lock-in amplifier 52 input as a reference signal with a waveform signal from the waveform generator 25. Accordingly, in the image acquiring device 50, an electromagnetic radiation image being a two-dimensional image within the inspection range of the semiconductor device S is acquired.

Here, in the configuration of FIG. 1, as the photoconductive element 40, an element fabricated with, for example, low-temperature grown GaAs can be preferably used. In this case, using second harmonic light of a wavelength of 529 nm as the probe light L2 is effective in improving the detection sensitivity of the electromagnetic wave in the photoconductive element. Moreover, as for the time-delay optical system 41, a configuration using the delay stage 42 and the reflecting mirrors 43 to 45 has been exemplified, but without limitation to such a configuration, various configurations, such as, for example, a configuration using a hollow retroreflector, may be used.

When the semiconductor device S is irradiated with the inspection light L1, simultaneously with the above-described electromagnetic wave being generated within the semiconductor device S, laser reflection light (return light) from the semiconductor device S is generated. This laser reflection light passes through an optical path opposite to that of the inspection light L1, is made incident into an optical fiber 29 via the polarization beam splitter 28, and detected by a photodetector such as a photodiode provided in the image acquiring device 50. Accordingly, in the image acquiring device 50, a laser reflection image being a two-dimensional image of the inspection range of the semiconductor device S is acquired in addition to the electromagnetic radiation image.

Moreover, for the semiconductor device S on the inspection stage 10, in addition to the laser light source 20 for supplying inspection light and the photoconductive element 40 for detecting electromagnetic waves, an illuminating device 15 and a CCD camera 16 for acquiring a normal CCD image of the semiconductor device S as a whole are provided. In the case of acquisition of a CCD image, illuminating light from the illuminating device 15 is reflected by a half-mirror 17, and the semiconductor device S is irradiated with the illuminating light via a relay lens 18, the half-mirror 33, the optical plate 34, and the objective lens 35. Moreover, light from the semiconductor device S passes through an optical path opposite to that of illuminating light, and passes through the half-mirror 17 to be imaged by the CCD camera 16. In addition, as the illuminating light from the illuminating device 15, near-infrared light is used, for example. In this case, even when near-infrared illuminating light is irradiated from the back surface of the semiconductor device S, an image of respective portions such as p-n junction portions of the semiconductor device S can be acquired by means of the CCD camera 16. The electromagnetic radiation image and laser reflection image acquired by the image acquiring device 50 and the CCD image imaged by the CCD camera 16 are input to an inspection control device 60 that controls an inspection of the semiconductor device S.

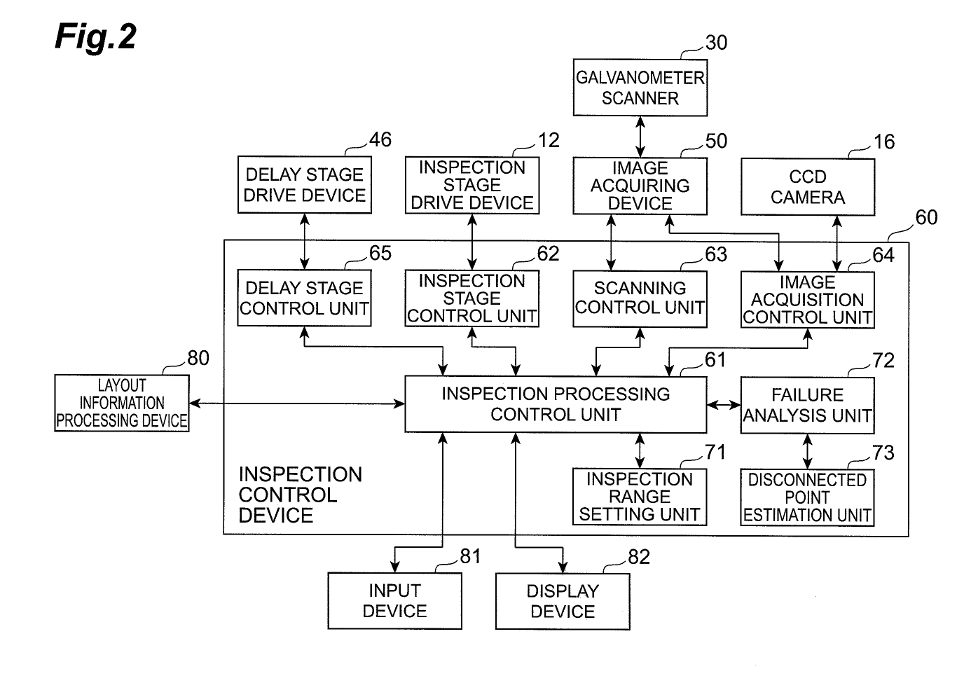

FIG. 2 is a block diagram showing an example of a configuration of the inspection control device 60. The inspection control device 60 of the present configuration example is configured having an inspection processing control unit 61, an inspection stage control unit 62, a scanning control unit 63, an image acquisition control unit 64, a delay stage control unit 65, an inspection range setting unit 71, a failure analysis unit 72, and a disconnected point estimation unit 73. The inspection processing control unit 61 controls the entire inspection processing to be executed in the semiconductor inspection apparatus 1A shown in FIG. 1.

The inspection control device 60 is connected with a layout information processing device 80 that supplies layout information indicating a configuration of p-n junction portions, wiring, and the like in the semiconductor device S, which is referred to in an inspection of the semiconductor device S. As the layout information processing device 80, for example, a CAD computer where a CAD software that handles design information such as arrangement of p-n junction portions and wiring of the semiconductor device has been activated can be used.

Here, as for the processing device 80, without limitation to the configuration being a separate device from the inspection control device 60, a configuration of the inspection control device 60 simultaneously having the function of a layout information processing device may be provided. Moreover, as for also the image acquiring device 50, a configuration of the inspection control device 60 simultaneously having the function of an image acquiring device may be provided. Moreover, the inspection control device 60 is further connected with an input device 81 to be used for input of an instruction and information necessary for a semiconductor inspection and a display device 82 for displaying information concerning a semiconductor inspection.

The inspection range setting unit 71 is setting means that, for the semiconductor device S, with reference to the layout information supplied from the processing device 80, sets an inspection range that needs to be two-dimensionally scanned by the inspection light L1 via the solid immersion lens 36 (inspection range setting step). The setting unit 71, preferably, based on an inspection object part such as a p-n junction portion extracted from the layout information of the semiconductor device S, automatically derives and sets the inspection range. Alternatively, the setting unit 71 may set the inspection range based on the content of an instruction input by an operator from the input device 81.

The inspection stage control unit 62 is position control means that, with reference to the layout information of the semiconductor device S, controls the position of the semiconductor device S with respect to the inspection light guide optical system to arrange the inspection range set by the setting unit 71 at a predetermined position with respect to the optical axis of the optical system (position control step). The control unit 62, by controlling driving of the inspection stage 10 via the inspection stage drive device 12, sets and changes the position of the semiconductor device S and the inspection range with respect to the optical axis of the optical system.

The scanning control unit 63 is scanning control means that controls driving of the galvanometer scanner 30 serving as scanning means via the image acquiring device 50 to control two-dimensional scanning by inspection light via the solid immersion lens 36 within the inspection range of the semiconductor device S (scanning control step). The image acquisition control unit 64 controls acquisition of an electromagnetic radiation image, a laser reflection image, and a CCD image by the image acquiring device 50 and the CCD camera 16, and is input with those acquired images to supply the same to the inspection processing control unit 61. Moreover, the delay stage control unit 65, by controlling driving of the time-delay stage 42 via the delay stage drive device 46, sets and changes the timing of the probe light L2 to be made incident onto the photoconductive element 40 to be a detection timing of electromagnetic waves.

The failure analysis unit 72 is failure analysis means that, based on a detection result of an electromagnetic wave by the photoconductive element 40, performs analysis (for example, a failure diagnosis) for a failure of the semiconductor device S (failure analysis step). By providing such a failure analysis unit 72, a failure diagnosis of the semiconductor device S in a zero-bias state can be preferably realized. Moreover, as an example of a specific analysis method, the failure analysis unit 72 applies a threshold to the detected intensity of the electromagnetic wave by the photoconductive element 40. Then, a method for discriminating whether the semiconductor device S is non-defective or defective depending on whether the detected intensity is within or outside of a non-defective intensity range set by the threshold can be used. According to such a method, a failure diagnosis of the semiconductor device S can be reliably executed.

Moreover, as an example of the specific content of a failure analysis, the failure analysis unit 72 discriminates whether a wire disconnection exists in the wiring included in the semiconductor device S as a failure of the semiconductor device S. Such a wiring failure in the semiconductor device S can be preferably diagnosed by the above-described inspection method. Moreover, in the configuration example shown in FIG. 2, in addition to the failure analysis unit 72, the disconnected point estimation unit 73 that, based on the layout information of the semiconductor device S and the analysis result in the failure analysis unit 72, estimates a disconnected point in the wiring included in the semiconductor device S is provided (disconnected point estimation step). According to the above-described inspection method, by referring to the detection result of electromagnetic waves, a disconnected point of the wiring in the semiconductor device S can be estimated. In addition, the inspection range setting method in the inspection range setting unit 71 and the data analysis method in the failure analysis unit 72 and the disconnected point estimation unit 73 will be specifically described later.

In addition, the processing to be executed in the inspection control device 60 shown in FIG. 2 can be realized by a control program for causing a computer to execute an inspection control processing. For example, the inspection control device 60 can be configured with a CPU that causes software programs required for the control processing to operate, a ROM in which the above-described software programs and the like are stored, and a RAM in which data is temporarily stored during execution of a program.

Moreover, the above-described programs for causing a control processing of a semiconductor inspection to be executed by a CPU can be distributed in a manner recorded on a computer readable recording medium. Examples of such a recording medium include magnetic media such as hard disks and flexible disks, optical media such as CD-ROMs and DVD-ROMs, magneto-optical media such as floptical disks, and hardware devices such as, for example, RAMs, ROMs, and semiconductor nonvolatile memories specially arranged so as to execute or store program instructions.

Effects of the semiconductor inspection apparatus and semiconductor inspection method according to the above-described embodiment will be described.

In the semiconductor inspection apparatus 1A and inspection method shown in FIG. 1 and FIG. 2, inspection is performed for the semiconductor device S in a zero-bias state by use of electromagnetic waves such as terahertz waves generated by irradiation of pulsed laser light. Accordingly, the semiconductor device S can be inspected in a non-contact manner. Moreover, the semiconductor device S as a whole is not two-dimensionally scanned with the inspection light L1, but in the inspection range setting unit 71, an inspection range is set with reference to the layout information indicating a configuration of p-n junction portions, wiring, and the like in the semiconductor device S, and two-dimensional scanning by the inspection light L1 is performed within the range. Accordingly, the measuring time required for the inspection processing can be reduced.

Moreover, in the above-described configuration, the position of the semiconductor device S is controlled with reference to the layout information to arrange the inspection range at a predetermined position (for example, a position on the optical axis) with respect to the optical axis of the optical system. Then, the semiconductor device S and the inspection stage 10 are fixed in that state, the solid immersion lens 36 is disposed for the semiconductor device S, and by the galvanometer scanner 30 being scanning means provided in the optical system, two-dimensional scanning is performed, via the solid immersion lens 36, by the inspection light L1 within the inspection range of the semiconductor device S. Further, an electromagnetic wave such as a terahertz wave emitted via the solid immersion lens 36 from the position irradiated with inspection light of the semiconductor device S is detected by the photoconductive element 40 to thereby perform inspection of the semiconductor device S.

Thus, by performing inspection with the solid immersion lens 36 disposed on the semiconductor device S, irradiation of inspection light and detection of electromagnetic waves can both be improved in position resolution by the solid immersion lens 36 so as to perform inspection in greater detail and accurately for the p-n junction portions, wiring, and the like included in the semiconductor device S. More specifically, by using the solid immersion lens 36 for a semiconductor inspection, the spot size of the inspection light L1 with which the semiconductor device S is irradiated can be reduced to improve the resolution, and the condensing efficiency of the electromagnetic wave generated in the semiconductor device S can also be improved.

Moreover, by fixing the inspection stage 10 holding the semiconductor device S so as to provide a configuration that allows performing two-dimensional scanning of the inspection light L1 by the scanning means on the optical system side, application of the solid immersion lens 36 to the semiconductor device S and two-dimensional scanning of the semiconductor device S by the inspection light L1 can both be preferably realized. By the above, the above-described configuration makes it possible to preferably perform an inspection in a zero-bias state for the semiconductor device S. Moreover, since the semiconductor inspection by the above-described method is a non-contact inspection, it is possible to, for example, conduct inspection in an in-line manner in the middle of a manufacturing process of the semiconductor device S. Moreover, it is also effective in the in-line inspection that the measuring time can be reduced as described above.

As for the scanning means for two-dimensional scanning of the inspection light L1, in the above-described embodiment, the galvanometer scanner 30 is used as the scanning means. Accordingly, it becomes possible to execute two-dimensional scanning of the semiconductor device S by the inspection light L1 at high speed and with high accuracy. Moreover, as the scanning means, various configurations such as, for example, a polygonal mirror scanner, may be specifically used besides the galvanometer scanner.

Moreover, as the solid immersion lens 36, a solid immersion lens made from semi-insulating GaP is preferably used. The solid immersion lens made from GaP has a high transparency to both of the inspection light L1 such as near-infrared light with which the semiconductor device S is irradiated and electromagnetic waves such as terahertz waves generated in the semiconductor device S. Therefore, such a solid immersion lens allows preferably conducting a semiconductor inspection.

Moreover, in the configuration shown in FIG. 1, the transparency to electromagnetic waves such as terahertz waves is required not only of the solid immersion lens 36, but also of the objective lens 35. As the objective lens 35 in this case, for example, a lens fabricated with a material made from cycloolefin having a high transparency and an equivalent refractive index to both near-infrared light and terahertz waves can be used. In addition, in terms of the lens material, various materials may be used besides the above-described materials. For example, as for the material of the solid immersion lens 36, without limitation to the above-described GaP, a material such as, for example, semi-insulating GaAs or diamond may be used. Generally, the solid immersion lens 36 is preferably made from a material having transparency for the inspection light with which the semiconductor device S is irradiated and the electromagnetic wave emitted from the semiconductor device S.

Moreover, as for the setting of the inspection range for the semiconductor device S in the inspection range setting unit 71, it is preferable to derive the inspection range based on an inspection object part extracted from the layout information. In the above-described method using electromagnetic waves generated by irradiation of pulsed laser light, electromagnetic waves are generated mainly at portions, such as p-n junction portions, where internal fields exist in a layout of the semiconductor device S. Therefore, extracting such a portion as an inspection object part from the layout information to derive the inspection range allows preferably setting the inspection range.

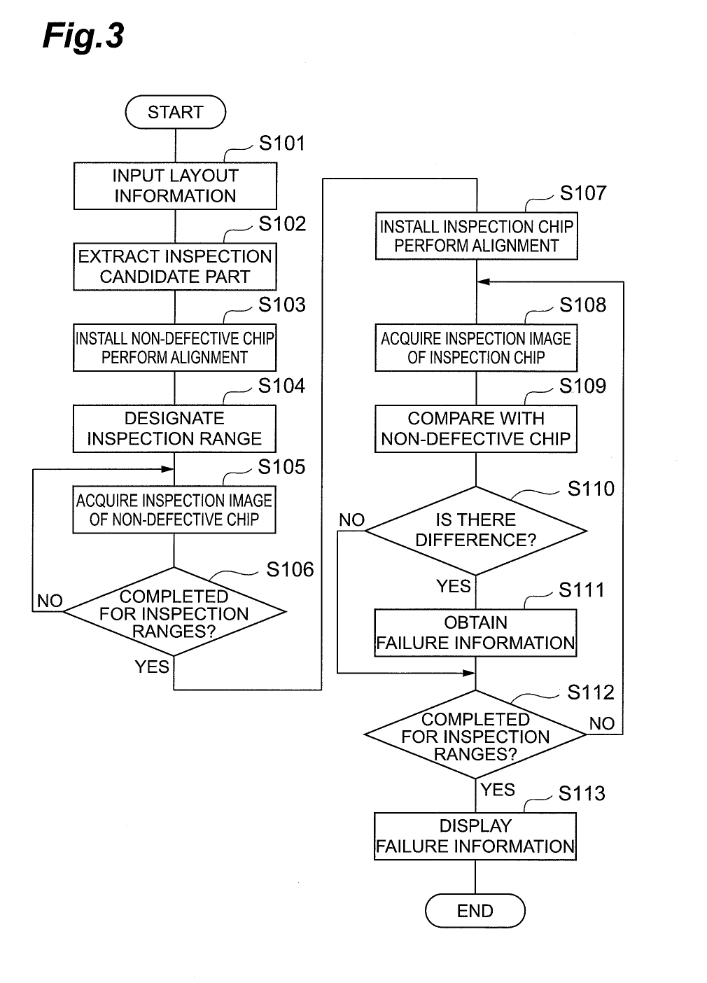

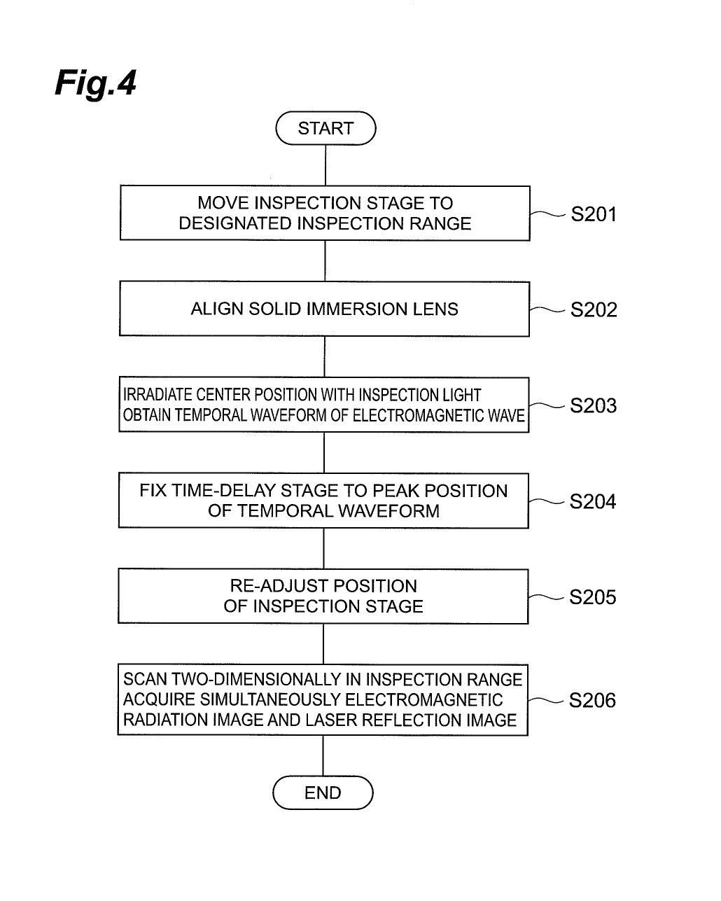

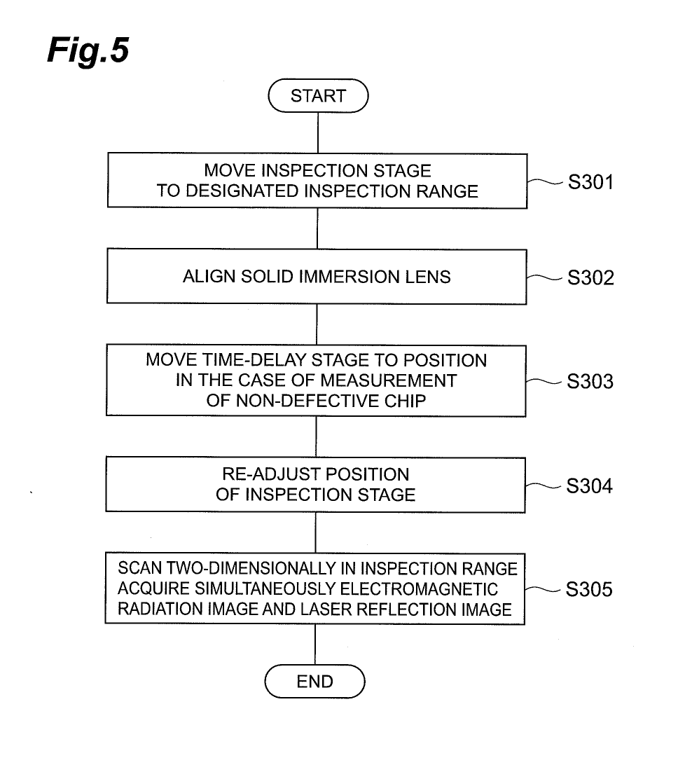

A further description will be given of the semiconductor inspection apparatus and inspection method according to the present invention along with a specific example of the inspection method. FIG. 3 is a flowchart showing an example of a semiconductor inspection method according to the present invention to be conducted using the semiconductor inspection apparatus 1A shown in FIG. 1 and FIG. 2. In the present example, shown is an example for comparing, for a chip of the semiconductor device S, an inspection result with a non-defective chip where no defective point exists and an inspection result with an inspection chip to be an actual inspection object to make a failure diagnosis on the semiconductor device S of the inspection chip. Moreover, FIG. 4 and FIG. 5 are flowcharts showing examples of a method for acquiring an inspection image of a non-defective chip and an inspection chip, respectively.

In the inspection method of the present example, first, layout information of the semiconductor device S being an inspection object is input to the layout information processing device 80 (step S101). In the processing device 80, inspection candidate parts in the semiconductor device S are extracted with reference to the input layout information (S102). Here, in a semiconductor inspection by detection of electromagnetic waves from the position irradiated with laser light, since it is assumed that electromagnetic waves are generated at portions, such as p-n junction portions and metal-semiconductor interfaces, where internal fields exist as described above, these portions within the semiconductor device S can be set as the inspection candidate parts. In the following, description will be given of the case as an example where p-n junction portions are taken as the inspection candidate parts.

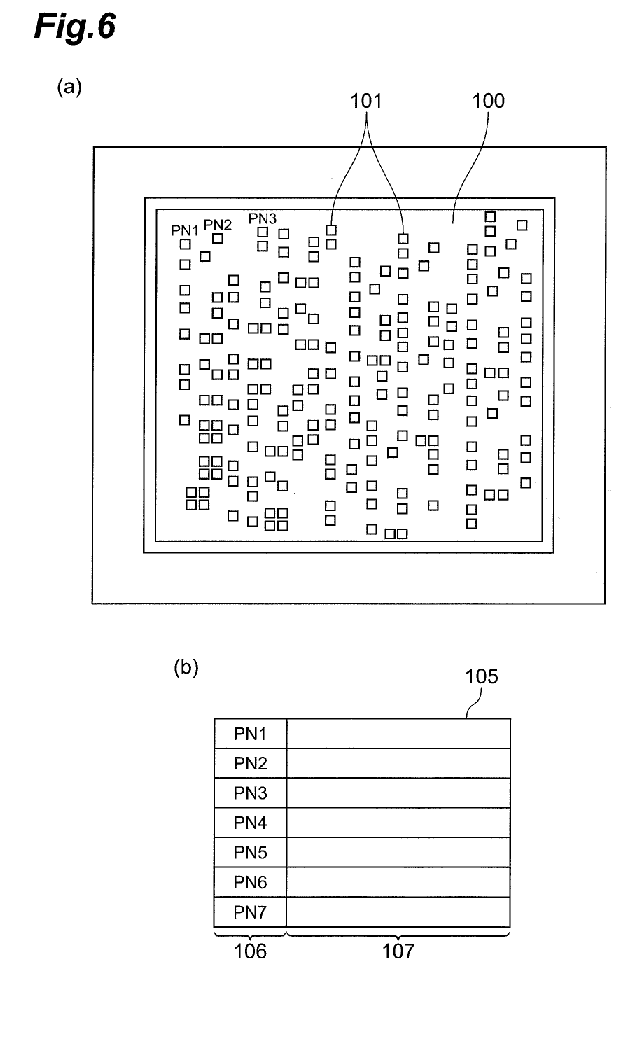

The information on the p-n junction portions extracted in the layout information processing device 80 is input to the inspection control device 60. FIG. 6 includes views showing an example of extraction of inspection candidate parts for a semiconductor device S. A plurality of p-n junction portions extracted as inspection candidate parts are, for convenience of an analysis processing, denoted with junction portion names (inspection candidate part names) such as PN1, PN2, PN3 . . . , respectively. Moreover, the information on the p-n junction portions input to the inspection control device 60 is displayed on the display device 82 according to necessity. In a display example (a) in FIG. 6, extracted p-n junction portions 101 are displayed in a layout image 100 showing the overall layout of the semiconductor device S.

In this display example (a), the junction portion names denoting the respective p-n junction portions may be simultaneously displayed. In the example of FIG. 6, the junction names are displayed for three p-n junction portions PN1, PN2, and PN3 located at the upper left Moreover, as for a display of the p-n junction portions, without limitation to the display example by the layout image 100, as shown in, for example, a display example (b), the p-n junction portions may be displayed by a list 105 of extracted p-n junction portions. In the display example (b), the list 105 consists of a junction portion name display section 106 that displays the junction portion names of p-n junction portions and an information display section 107 that displays position information and the like on the respective p-n junction portions.

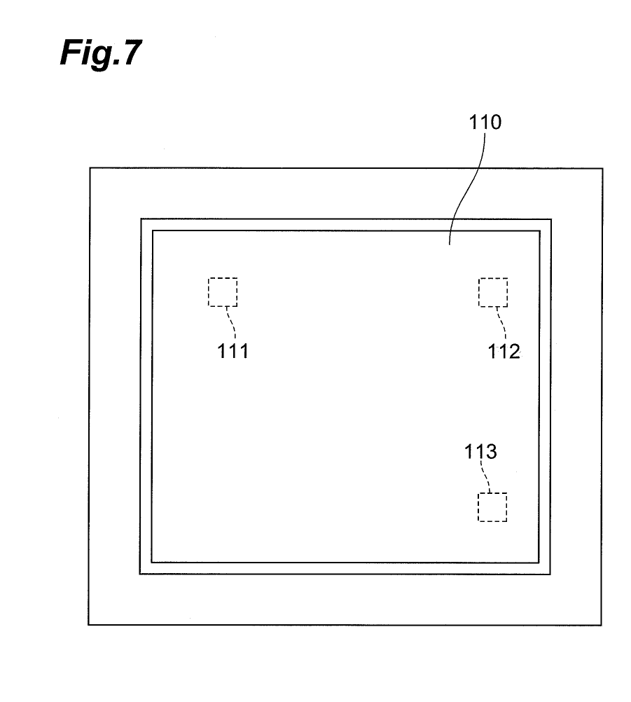

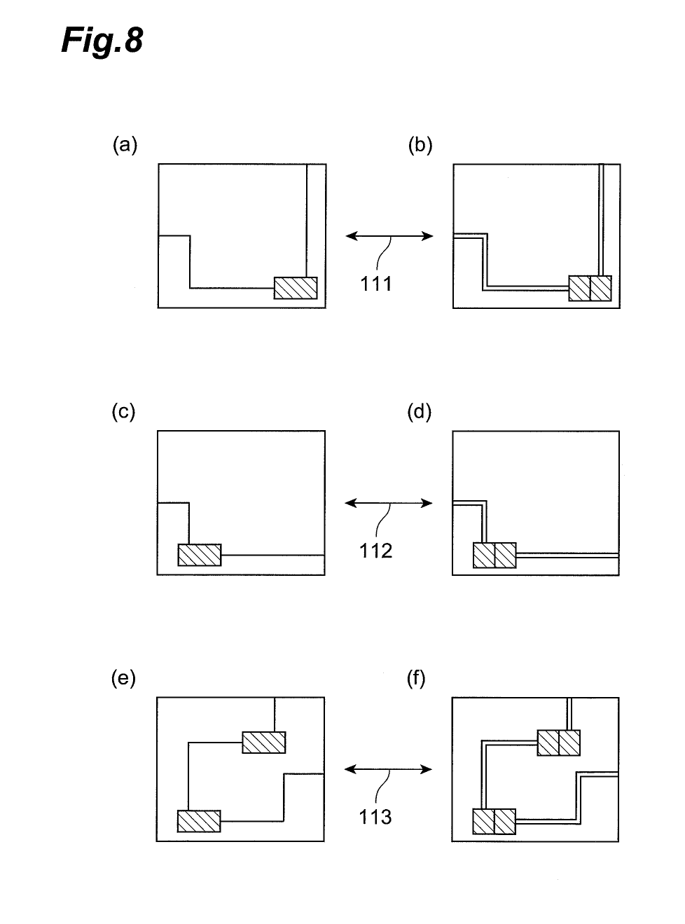

Next, a non-defective chip of the semiconductor device S is disposed on the inspection stage 10, and a chip image of the non-defective chip as a whole is acquired by the CCD camera 16, and the layout image and the chip image are aligned therebetween (S103). FIG. 7 and FIG. 8 are views showing an example of alignment of a layout image and a chip image of the semiconductor device S. Here, shown is a method for alignment by selecting three separated points on a semiconductor chip, and correlating the coordinates on the layout image of those three points with the coordinates on the chip image.

FIG. 7 shows a layout image 110 of the semiconductor device S as a whole to be an object of alignment, the images (a) and (b) in FIG. 8 show enlarged views of the layout image and the chip image for a region 111 located at the upper left in the layout image 110 of FIG. 7, the images (c) and (d) in FIG. 8 show enlarged views of the layout image and the chip image for a region 112 located at the upper right in the layout image 110, and images (e) and (f) in FIG. 8 show enlarged views of the layout image and the chip image for a region 113 located at the lower right in the layout image 110. In the above-described alignment method, by, for example, selecting one point each in these three regions 111 to 113, the layout image and the chip image can be aligned with each other.

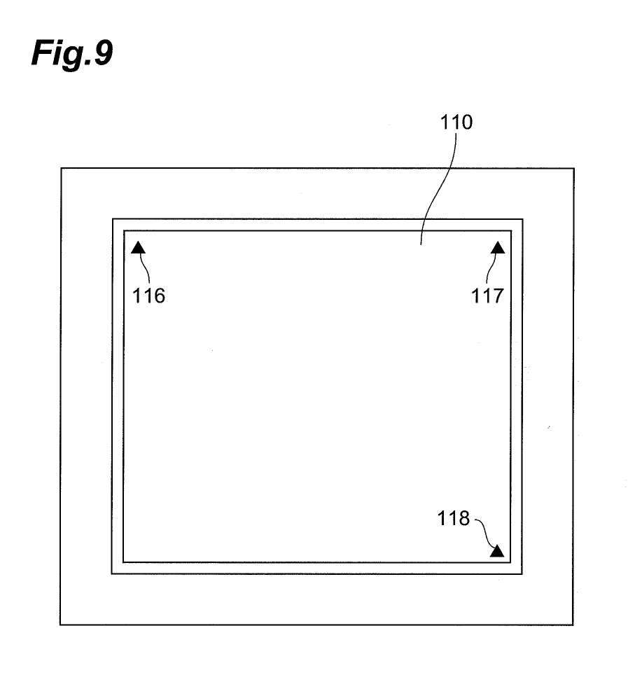

In a state applied with such alignment, designating a position on a CAD layout allows designating a position in the semiconductor device S on the inspection stage 10 correlated therewith in an inspection of the semiconductor device S. In addition, as for a specific method of the alignment, various methods may be used besides the above. Examples of such methods include, as shown in FIG. 9, a method for alignment using alignment marks 116 to 118 provided in advance for alignment in a layout of the semiconductor device S.

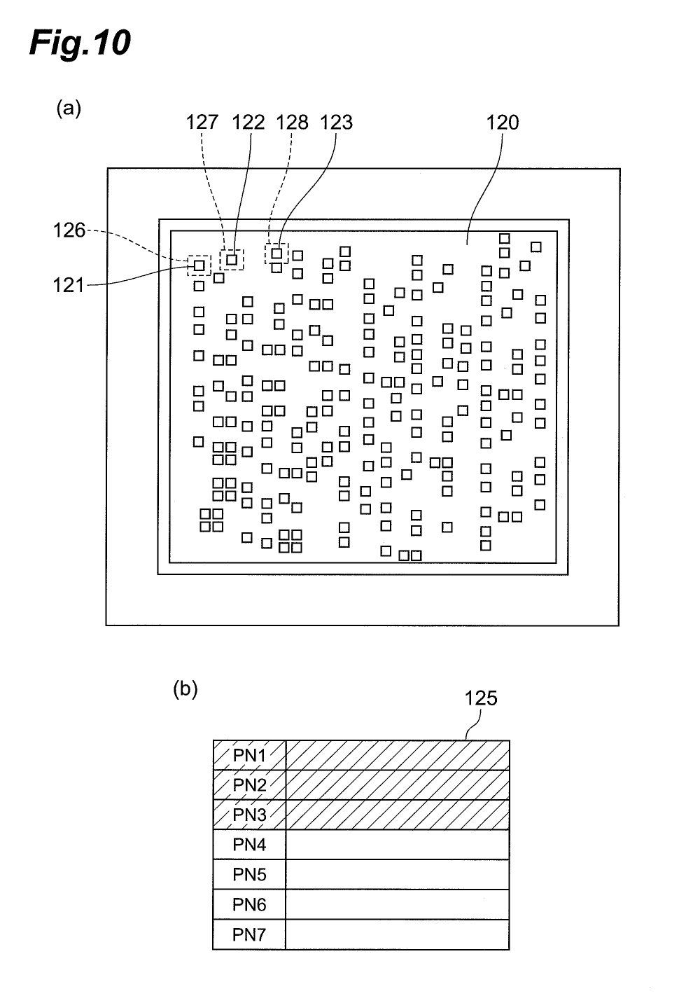

Once the alignment between the layout of the semiconductor device S and the chip image is completed, an inspection object part that needs to be actually inspected among the p-n junction portions on the layout is designated, and an inspection range corresponding thereto is set (S104). Specifically, as shown in FIG. 10, a p-n junction portion to be designated as an inspection object part is selected by an operation such as clicking a p-n junction portion that needs to be inspected in a layout image 120 of a display example (a) or a list 125 of a display example (b). In the inspection range setting unit 71, an inspection range is derived based on the designated inspection object part. In FIG. 10, shown is an example where three p-n junction portions PN1, PN2, and PN3 are designated as inspection object parts, and inspection ranges 126, 127, and 128 are set for those inspection object parts 121, 122, and 123, respectively.

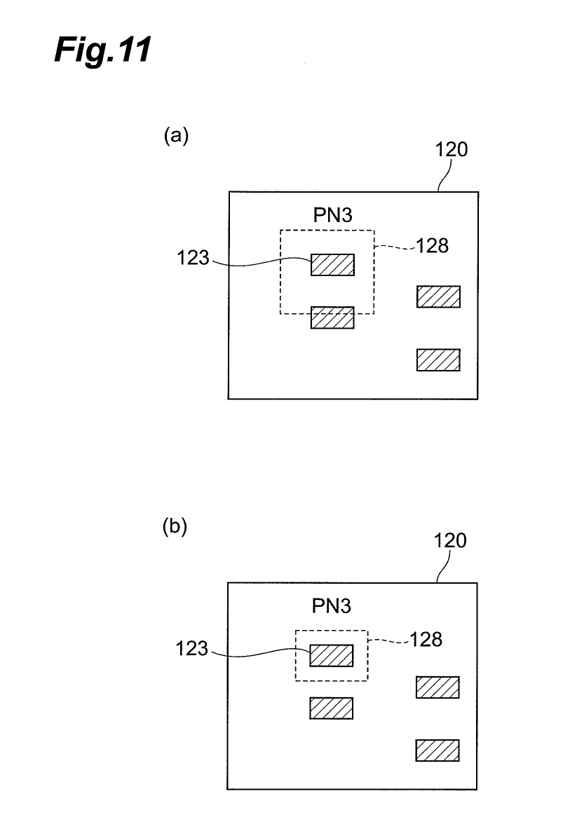

In addition, as the specific inspection range setting method, various methods may be used besides the above-described method. For example, as shown in FIG. 11 as a setting example of the inspection range 128 for the inspection object part 123 of the p-n junction portion PN3, there may be the configuration for, in terms of an inspection range 128 automatically calculated by the setting unit 71 as in (a) in FIG. 11, manually changing the range by an operator according to necessity as in (b) in FIG. 11. Moreover, there may be a configuration for an operator freely setting an inspection range on the layout, without designating an inspection object part from the inspection candidate parts extracted from the layout information.

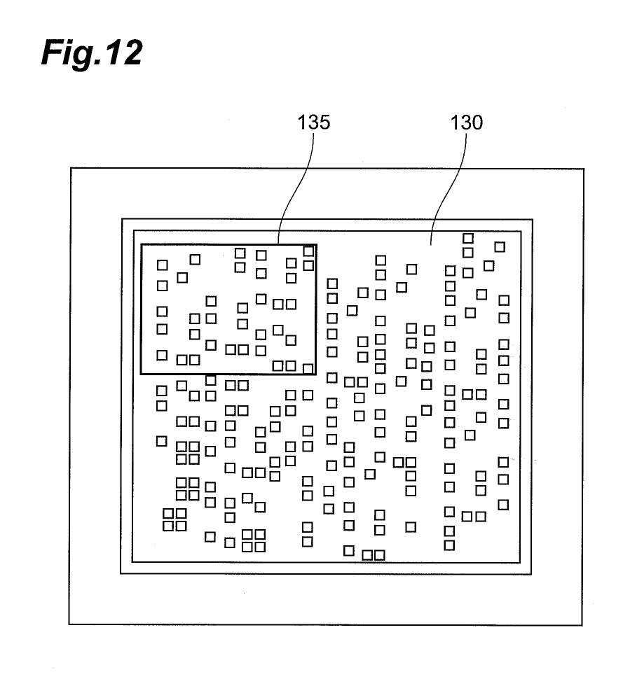

Moreover, there may be a configuration that, for designated inspection object parts and inspection ranges, allows making an addition, reduction, or change of the inspection range according to necessity. Moreover, as shown in FIG. 12, there may be a configuration for, by designating an inspection object range 135 for p-n junction portions of inspection candidate parts present on a layout image 130, designating all p-n junction portions present within the range 135 in a lump as inspection object parts, and setting an inspection range for each thereof.

Once the setting of the inspection range for the semiconductor device S is completed, for the non-defective chip on the inspection stage 10, inspection images including an electromagnetic radiation image and a laser reflection image are acquired for each of one or a plurality of inspection ranges thus set (S105). FIG. 4 is a flowchart showing an example of a method for acquiring an inspection image of a non-defective chip.

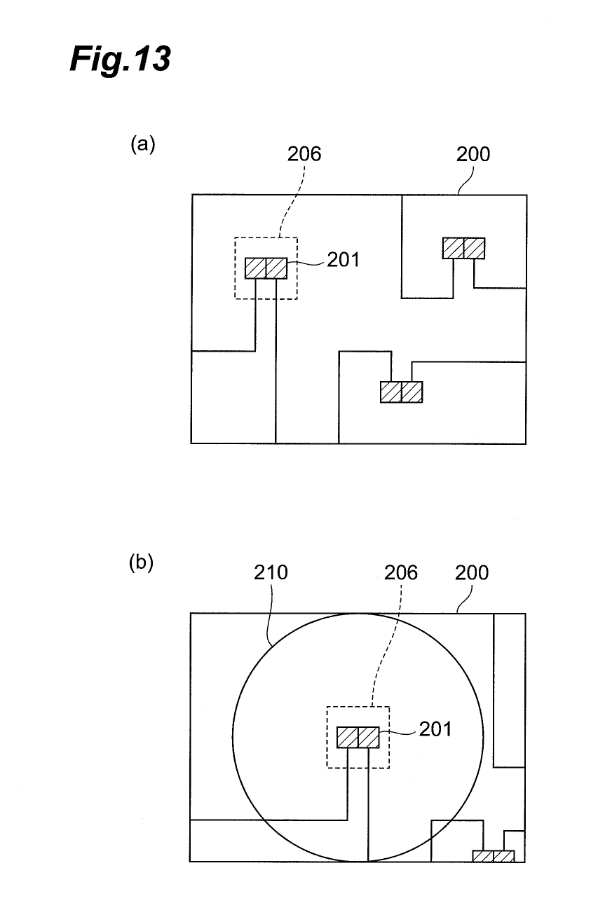

In acquisition of an inspection image of the non-defective chip, first, as shown in (a) in FIG. 13, for an inspection range 206 including a p-n junction portion designated as an inspection object part 201 on a layout 200 of the semiconductor device S, driving of the inspection stage 10 is controlled via the drive device 12 by the inspection stage control unit 62. Then, as shown in (b) in FIG. 13, the position of the non-defective chip is controlled so that the designated inspection range 206 is located on the optical axis of the optical system (S201). Further, with respect to this inspection range 206, the solid immersion lens 36 is aligned as shown by a circle 210 in (b) in FIG. 13 as a disposing range of the solid immersion lens 36, and as shown in FIG. 1, the solid immersion lens 36 is disposed in a state optically closely contacted with the non-defective chip (S202).

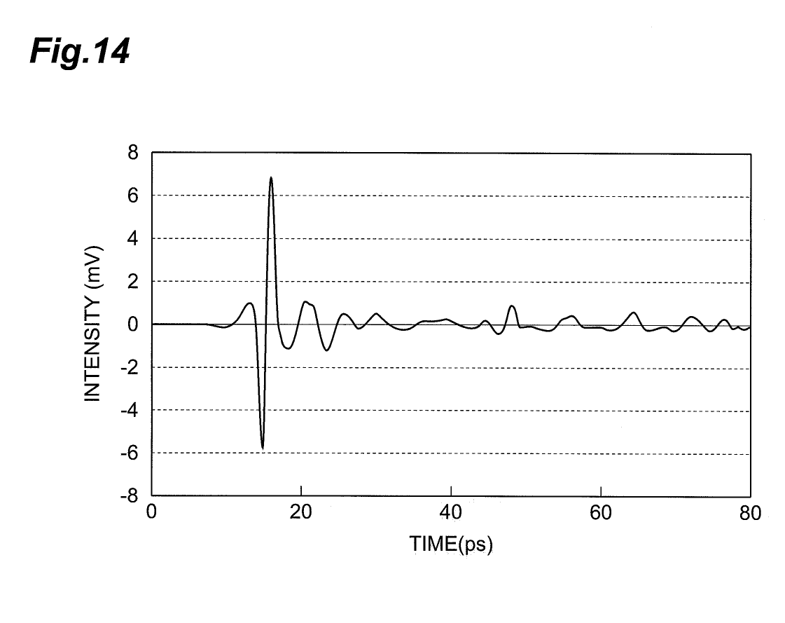

Next, a center position of the inspection range 206 is irradiated with the inspection light L1 in this state, and the temporal waveform of the electromagnetic wave generated in the p-n junction portion 201 is obtained (S203). Specifically, the non-defective chip on the inspection stage 10 is irradiated with the inspection light L1, and an electromagnetic wave such as a terahertz wave generated at the position irradiated with the inspection light is detected by the photoconductive element 40 via the solid immersion lens 36 and the objective lens 35. By changing the position of the time-delay stage 42 while performing such electromagnetic wave detection, the temporal waveform of the electromagnetic wave as shown in, for example, FIG. 14 is obtained.

Subsequently, an optimal detection timing for electromagnetic wave detection is determined with reference to the obtained temporal waveform of the electromagnetic wave, and the time-delay stage 42 is fixed to a position corresponding to that timing (S204). Examples of a specific method for determining the timing in this case includes a method for fixing the delay stage 42 to a position to have, in the temporal waveform of the terahertz wave in FIG. 14, a time delay corresponding to a peak position in intensity thereof. Moreover, the determined position of the delay stage 42 is stored in the inspection control device 60.

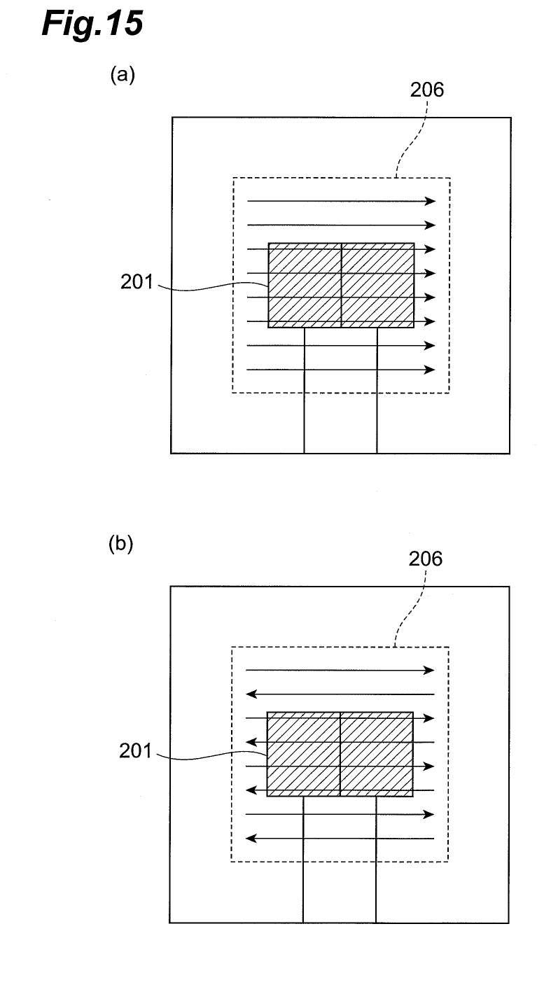

Once the delay stage 42 is fixed, the position of the inspection stage 10 is re-adjusted (S205), the inspection light L1 is two-dimensionally scanned within the inspection range 206 to acquire an electromagnetic radiation image and a laser reflection image simultaneously (S206), and the acquired images are stored in the inspection control device 60. Here, as for the two-dimensional scanning of the inspection light L1 for the semiconductor device S, for example, as shown in (a) in FIG. 15, a method for two-dimensionally scanning by repeating one-dimensional scanning in the same direction within the inspection range 206 can be used. Alternatively, as shown in (b) in FIG. 15, a method for two-dimensionally scanning by repeating one-dimensional scanning in directions alternately changed within the inspection range 206 may be used.

Moreover, in the case of displaying an acquired inspection image on the display device 82, an electromagnetic radiation image and a laser reflection image may be each individually displayed, and alternatively, a superimposed image of an electromagnetic radiation image and a laser reflection image may be displayed.

Once the image acquisition processing for the designated inspection range is completed by the above, it is judged whether image acquisition has been completed for all inspection ranges (S106). Then, if there is an inspection range where image acquisition has not been completed, the above-described image acquisition processing is repeatedly executed. If image acquisition has been completed, the inspection processing for the non-defective chip ends, and the process shifts to an inspection processing of an inspection chip. In addition, when another inspection range for which image acquisition is possible within a setting range of the solid immersion lens 36 in the last image acquisition exists in the image acquisition for inspection ranges, image acquisition may be performed in an unchanged state to reduce the inspection time.

Next, an inspection chip to be an actual inspection object is disposed on the inspection stage 10, a chip image of the inspection chip as a whole is acquired by the CCD camera 16, and the layout image and the chip image are aligned therebetween (S107). A method for alignment to be performed here is the same as the alignment method in the case of the non-defective chip described above regarding step S103. Once the alignment is completed, acquisition of inspection images including an electromagnetic radiation image and a laser reflection image is performed for the same inspection range as that specified for the non-defective chip (S108). FIG. 5 is a flowchart showing an example of a method for acquiring an inspection image of an inspection chip.

In acquisition of an inspection image of the inspection chip, first, driving of the inspection stage 10 is controlled to control the position of the inspection chip so that the designated inspection range is located on the optical axis of the optical system (S301). Further, with respect to the inspection range, the solid immersion lens 36 is aligned, and is disposed in a state optically closely contacted with the inspection chip (S302). Moreover, the time-delay stage 42 is moved and fixed to the position of the delay stage 42 that has been determined for the non-defective chip (S303).

Once the delay stage 42 is fixed, the position of the inspection stage 10 is re-adjusted (S304), the inspection light L1 is two-dimensionally scanned within the inspection range to acquire an electromagnetic radiation image and a laser reflection image of the inspection chip simultaneously (S305), and the acquired images are stored in the inspection control device 60.

Once the image acquisition processing for the designated inspection range is completed by the above, inspection image data of the inspection chip and inspection image data of the non-defective chip are compared with each other, and analysis as to whether a failure exists in the inspection chip is performed (S109). Subsequently, it is judged whether there is a difference between the inspection chip and the non-defective chip as a result of comparison therebetween (whether the inspection chip is a non-defective product or a defective product) (S110), and when there is a difference therebetween (when the inspection chip is a defective chip), further detailed failure information is obtained according to necessity (S111).

Once the image acquisition processing for the designated inspection range, and the inspection processing including a failure analysis processing using the obtained images are completed by the above, it is judged whether an inspection processing has been completed for all inspection ranges (S112). Then, if there is an inspection range where an inspection processing has not been completed, the above-described processing is repeatedly executed. If an inspection processing has been completed, an obtained failure analysis result is displayed on the display device 82 (S113), and the inspection of the inspection chip ends.

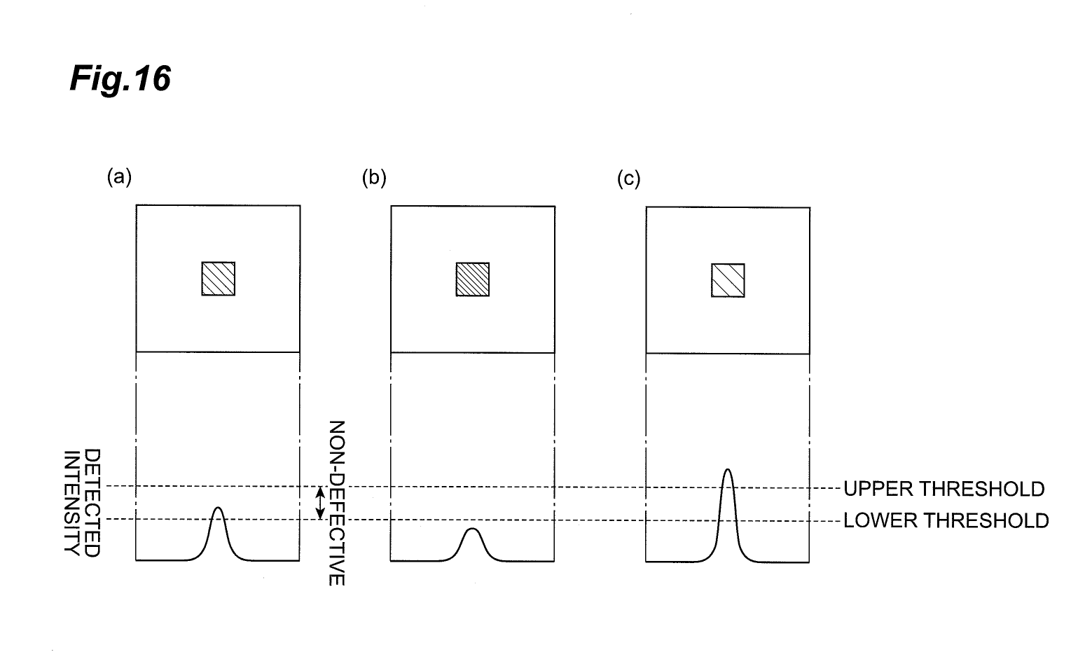

Here, the failure analysis by comparison between the non-defective chip and the inspection chip in step S109 is performed, for example, with reference to the detected intensity of the electromagnetic wave in the electromagnetic radiation image (THz wave radiation image). FIG. 16 includes views showing an example of a failure analysis method by using the detected intensity of the terahertz wave. In FIG. 16, (a) in FIG. 16 shows two-dimensional and one-dimensional intensity distributions of electromagnetic waves in a non-defective chip, (b) in FIG. 16 shows a first example of intensity distributions of electromagnetic waves in a defective chip, and (c) in FIG. 16 shows a second example of intensity distributions of electromagnetic waves in a defective chip.

In FIG. 16, used is a method, as an example of a method for failure analysis of the semiconductor device S, of applying a threshold to the detected intensity of the electromagnetic wave by the photoconductive element 40, and discriminating whether the semiconductor device S is non-defective or defective according to whether the detected intensity is within or outside of the non-defective intensity range set by the threshold. Specifically, as shown in (a) in FIG. 16, with reference to the detected intensity distributions of electromagnetic waves in a non-defective chip, a non-defective intensity range is set by a lower threshold and an upper threshold for the peak detected intensity within the inspection range.

Then, the inspection chip is determined to be a non-defective chip when the obtained peak detected intensity is within the non-defective intensity range, and on the other hand, the inspection chip is determined to be a defective chip when the peak detected intensity is outside of the non-defective intensity range. (b) in FIG. 16 shows an example of defective data when the peak detected intensity falls below the lower threshold, and (c) in FIG. 16 shows an example of defective data when the peak detected intensity exceeds the upper threshold.

In addition, in such failure analysis by using the detected intensity of electromagnetic waves, without limitation to the method using the peak detected intensity within the inspection range as described above, various methods such as, for example, a method using an average value of detected intensities within an inspection range or a total detected intensity for a failure analysis, may be specifically used. Moreover, as for the setting of the non-defective intensity range, either one of the lower threshold and upper threshold may be used. Moreover, there may be a configuration for taking a difference between the detected intensity data of the non-defective chip and the detected intensity data of the inspection chip, and performing failure analysis by use of this difference value.

Moreover, examples of acquisition of detailed failure information to be performed, when the inspection chip is a defective chip, in step S111 include an estimation processing of a disconnected point in the wiring of the semiconductor device S, to be executed in the disconnected point estimation unit 73. Here, according to Non Patent Document 1, it has been reported that the signal intensity of terahertz waves to be emitted from the semiconductor device S depends on the wiring length. By using such dependence on the wiring length of the signal intensity of the terahertz wave, it is possible to estimate a disconnected point in the wiring.

Specifically, first, for a p-n junction portion to be an inspection object in a layout of the semiconductor device S, correlation data of the wiring length of a wiring line connected to the p-n junction portion and the detected intensity of the electromagnetic wave emitted from the p-n junction portion is obtained from the measurement result of the non-defective chip. Next, the detected intensity of the electromagnetic wave from a corresponding p-n junction portion is determined for the defective chip, and the wiring length from a connecting portion between the p-n junction portion and the wiring line is calculated with reference to the above-described correlation data. Accordingly, a disconnected point in the wiring can be estimated.

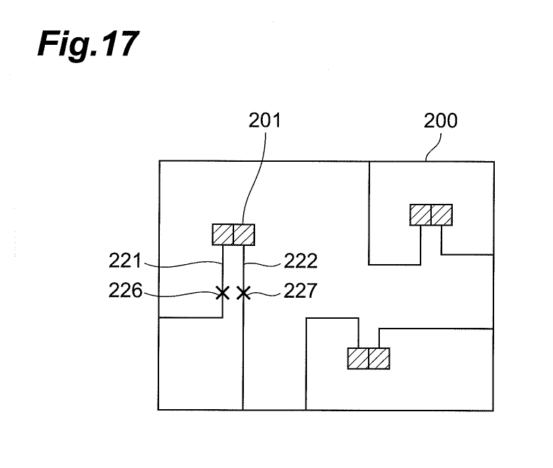

FIG. 17 is a view showing an example of a method for estimating a disconnected point in wiring of a semiconductor device S. In this example, in response to that two wiring lines 221, 222 are connected to the p-n junction portion 201 on the layout 200, based on the wiring length determined from the detected intensity of the electromagnetic wave, disconnected points 226, 227 are estimated for the respective wiring lines. Displaying such a layout 200 as a layout image on the display device 82 allows an operator to obtain information concerning an estimated disconnected point. Such failure analysis is effective in such a case as, for example, performing failure analysis (for example, physical analysis) of a defective chip in an off-line manner.

The semiconductor inspection apparatus and semiconductor inspection method according to the present invention is not limited to the embodiment and configuration examples described above, and various modifications can be made. For example, in the above-described embodiment, setting and adjustment of the position of the semiconductor device S with respect to the optical system is performed by a configuration for driving the inspection stage 10, but besides such a configuration, for example, a configuration for driving the optical system side with the stage 10 fixed may be used.

Moreover, as for the electromagnetic wave detection means that detects electromagnetic waves such as terahertz waves from the semiconductor device S, the photoconductive element 40 is used in the above-described embodiment, but detection means other than a photoconductive element capable of detecting electromagnetic waves may be used. Moreover, as for also the configuration of an optical system for inspection light, probe light, and electromagnetic waves, FIG. 1 shows an example thereof, and various configurations may be specifically used besides this.

Moreover, as for the arrangement of the optical system and solid immersion lens with respect to the semiconductor device S, shown is a configuration for performing irradiation of inspection light and detection of electromagnetic waves for the semiconductor device S from the downside in the above-described embodiment, but the present invention is not limited to such a configuration, and for example, a configuration for performing irradiation of inspection light and detection of electromagnetic waves for a semiconductor device from the upside may be provided. In this case, the solid immersion lens is disposed at the upside of the semiconductor device. Alternatively, a configuration for performing irradiation of inspection light for a semiconductor device from one side of the upside and downside, and detection of electromagnetic waves from the other side may be provided. In this case, the solid immersion lens is disposed at both the upside and downside of the semiconductor device, respectively.

Here, in the semiconductor inspection apparatus according to the above-described embodiment, used is a configuration comprising: (1) an inspection stage that holds a semiconductor device in a zero-bias state to be an inspection object; (2) a laser light source that irradiates the semiconductor device with pulsed laser light as inspection light; (3) an inspection light guide optical system that guides the inspection light from the laser light source to the semiconductor device, and includes scanning means that controls an optical path of the inspection light for two-dimensionally scanning by the inspection light within an inspection range set for the semiconductor device; (4) a solid immersion lens, that is disposed between the semiconductor device and the inspection light guide optical system, and that condenses the inspection light while irradiating the semiconductor device with the inspection light from the inspection light guide optical system; (5) electromagnetic wave detection means that detects an electromagnetic wave generated in the semiconductor device by irradiation of the inspection light, and emitted via the solid immersion lens; and (6) inspection control means that controls inspection of the semiconductor device, and the inspection control means including: inspection range setting means that, for the semiconductor device, with reference to layout information thereof, sets the inspection range that needs to be two-dimensionally scanned by the inspection light via the solid immersion lens; position control means that, with reference to the layout information of the semiconductor device, controls a position of the semiconductor device with respect to the inspection light guide optical system to arrange the inspection range at a predetermined position with respect to an optical axis; and scanning control means that controls driving of the scanning means to control two-dimensional scanning by the inspection light via the solid immersion lens within the inspection range of the semiconductor device.

Moreover, in the semiconductor inspection method according to the above-described embodiment, used is a configuration using a semiconductor inspection apparatus including (1) an inspection stage that holds a semiconductor device in a zero-bias state to be an inspection object; (2) a laser light source that irradiates the semiconductor device with pulsed laser light as inspection light; (3) an inspection light guide optical system that guides the inspection light from the laser light source to the semiconductor device, and includes scanning means that controls an optical path of the inspection light for two-dimensionally scanning by the inspection light within an inspection range set for the semiconductor device; (4) a solid immersion lens, that is disposed between the semiconductor device and the inspection light guide optical system, and that condenses the inspection light while irradiating the semiconductor device with the inspection light from the inspection light guide optical system; and (5) electromagnetic wave detection means that detects an electromagnetic wave generated in the semiconductor device by irradiation of the inspection light, and emitted via the solid immersion lens; and the method comprising: (6) an inspection range setting step of setting, for the semiconductor device, with reference to layout information thereof, the inspection range that needs to be two-dimensionally scanned by the inspection light via the solid immersion lens; a position control step of controlling, with reference to the layout information of the semiconductor device, a position of the semiconductor device with respect to the inspection light guide optical system to arrange the inspection range at a predetermined position with respect to an optical axis; and a scanning control step of controlling driving of the scanning means to control two-dimensional scanning by the inspection light via the solid immersion lens within the inspection range of the semiconductor device.

For a specific configuration of the inspection light guide optical system, it is preferable that the scanning means for two-dimensional scanning of the inspection light includes a galvanometer scanner for controlling the optical path of the inspection light. Accordingly, it becomes possible to execute two-dimensional scanning of the semiconductor device by the inspection light at high speed and with high accuracy.

Moreover, as the solid immersion lens, it is preferable to use a solid immersion lens made from a material having transparency to the inspection light with which the semiconductor device is irradiated and the electromagnetic wave emitted from the semiconductor device. Moreover, as an example of such a solid immersion lens, it is particularly preferable to use a solid immersion lens made from GaP (gallium phosphide).

In a semiconductor inspection with the above-described configuration, for example, laser light having a wavelength in the near-infrared region (laser light of a wavelength of, for example, 750 nm to 2500 nm) is used as the pulsed laser light to serve as the inspection light. On the other hand, the solid immersion lens made from a material such as GaP has high transparency to both of near-infrared inspection light with which the semiconductor device is irradiated and electromagnetic waves such as terahertz waves (electromagnetic waves of a frequency of, for example, 0.1 THz to 10 THz) generated in the semiconductor device. Therefore, by using such a solid immersion lens, the above-described semiconductor inspection can be preferably executed.

For the setting of the inspection range for the semiconductor device, it is preferable to derive the inspection range based on an inspection object part extracted from the layout information of the semiconductor device. In the above-described method using electromagnetic waves generated by irradiation of pulsed laser light, electromagnetic waves are generated mainly at portions, such as p-n junction portions, where internal fields exist in a layout of the semiconductor device. Therefore, extracting such a portion as an inspection object part from the layout information to derive an inspection range allows preferably setting an inspection range.

Moreover, it is preferable for the semiconductor inspection apparatus that the inspection control means includes failure analysis means performing analysis on a failure of the semiconductor device based on a detection result of the electromagnetic wave by the electromagnetic wave detection means. Similarly, it is preferable that the inspection method includes a failure analysis step of performing analysis on a failure of the semiconductor device based on a detection result of the electromagnetic wave by the electromagnetic wave detection means. According to such a configuration, a failure diagnosis of the semiconductor device in a zero-bias state can be preferably executed.

For a specific method for failure analysis in this case, a configuration for applying one or a plurality of thresholds to a detected intensity of the electromagnetic wave by the electromagnetic wave detection means, and depending on whether the detected intensity is within or outside of a non-defective intensity range set by the threshold, discriminating whether the semiconductor device is non-defective or defective can be used. According to such a method, a failure diagnosis of the semiconductor device by detection of electromagnetic waves can be reliably executed.

Moreover, for the content of a specific failure analysis for the semiconductor device, a configuration for discriminating whether a wire disconnection exists in wiring included in the semiconductor device as a failure of the semiconductor device can be used. Such a wiring defect in the semiconductor device can be preferably diagnosed by the above-described inspection method.

Moreover, it is preferable for the semiconductor inspection apparatus that the inspection control means includes disconnected point estimation means estimating a disconnected point in wiring included in the semiconductor device based on the layout information of the semiconductor device and an analysis result in the failure analysis means. Similarly, it is preferable that the inspection method includes a disconnected point estimation step of estimating a disconnected point in wiring included in the semiconductor device based on the layout information of the semiconductor device and an analysis result in the failure analysis step. According to the above-described inspection method, by referring to the detection result of electromagnetic waves by the electromagnetic wave detection means, a disconnected point of the wiring in the semiconductor device can be estimated.

### INDUSTRIAL APPLICABILITY

The present invention can be used as a semiconductor inspection apparatus and semiconductor inspection method capable of preferably performing an inspection in a zero-bias state for a semiconductor device.

### REFERENCE SIGNS LIST

1A—semiconductor inspection apparatus, 21—semiconductor device, 10—inspection stage, 11—opening, 12—inspection stage drive device, 15—illuminating device, 16—CCD camera, 17—half-mirror, 18—lens,
20—pulsed laser light source, 21—SHG element, 22—reflecting mirror, 23—harmonic separator, 24—modulation device, 25—waveform generator, 26—beam expander, 27—wave plate, 28—polarization beam splitter, 29—optical fiber, 30—galvanometer scanner, 31—wave plate, 32—lens, 33—half-mirror, 34—ITO coated optical plate, 35—objective lens, 36—solid immersion lens, 37—lens,
40—photoconductive element, 41—time-delay optical system, 42—time-delay stage, 43, 44, 45—reflecting mirror, 46—delay stage drive device, 47—lens, 50—image acquiring device, 51—current amplifier, 52—lock-in amplifier,
60—inspection control device, 61—inspection processing control unit, 62—inspection stage control unit, 63—scanning control unit, 64—image acquisition control unit, 65—delay stage control unit, 71—inspection range setting unit, 72—failure analysis unit, 73—disconnected point estimation unit, 80—layout information processing device, 81—input device, 82—display device.

1. A semiconductor inspection apparatus comprising:
an inspection stage holding a semiconductor device in a zero-bias state to be an inspection object;
a laser light source irradiating the semiconductor device with pulsed laser light as inspection light;
an inspection light guide optical system guiding the inspection light from the laser light source to the semiconductor device, and including scanning means that controls an optical path of the inspection light for two-dimensionally scanning by the inspection light within an inspection range set for the semiconductor device;
a solid immersion lens, disposed between the semiconductor device and the inspection light guide optical system, and condensing the inspection light while irradiating the semiconductor device with the inspection light from the inspection light guide optical system;
electromagnetic wave detection means detecting an electromagnetic wave generated in the semiconductor device by irradiation of the inspection light, and emitted via the solid immersion lens; and
inspection control means controlling inspection of the semiconductor device, wherein
the inspection control means includes:
inspection range setting means setting, for the semiconductor device, with reference to layout information thereof, the inspection range that needs to be two-dimensionally scanned by the inspection light via the solid immersion lens;
position control means controlling, with reference to the layout information of the semiconductor device, a position of the semiconductor device with respect to the inspection light guide optical system to arrange the inspection range at a predetermined position with respect to an optical axis; and
scanning control means controlling driving of the scanning means to control two-dimensional scanning by the inspection light via the solid immersion lens within the inspection range of the semiconductor device.

2. The semiconductor inspection apparatus according to claim 1, wherein the inspection range setting means derives the inspection range based on an inspection object part extracted from the layout information of the semiconductor device.

3. The semiconductor inspection apparatus according to claim 1, wherein the inspection control means includes failure analysis means performing analysis on a failure of the semiconductor device based on a detection result of the electromagnetic wave by the electromagnetic wave detection means.

4. The semiconductor inspection apparatus according to claim 3, wherein the failure analysis means applies a threshold to a detected intensity of the electromagnetic wave by the electromagnetic wave detection means, and depending on whether the detected intensity is within or outside of a non-defective intensity range set by the threshold, discriminates whether the semiconductor device is non-defective or defective.

5. The semiconductor inspection apparatus according to claim 3, wherein the failure analysis means discriminates whether a wire disconnection exists in wiring included in the semiconductor device as a failure of the semiconductor device.

6. The semiconductor inspection apparatus according to claim 5, wherein the inspection control means includes disconnected point estimation means estimating a disconnected point in wiring included in the semiconductor device based on the layout information of the semiconductor device and an analysis result in the failure analysis means.

7. The semiconductor inspection apparatus according to claim 1, wherein the scanning means includes a galvanometer scanner for controlling the optical path of the inspection light.

8. The semiconductor inspection apparatus according to claim 1, wherein the solid immersion lens is made from a material having transparency for the inspection light with which the semiconductor device is irradiated and the electromagnetic wave emitted from the semiconductor device.

9. The semiconductor inspection apparatus according to claim 8, wherein the solid immersion lens is made from GaP (gallium phosphide).

10. A semiconductor inspection method using a semiconductor inspection apparatus including:
an inspection stage holding a semiconductor device in a zero-bias state to be an inspection object;
a laser light source irradiating the semiconductor device with pulsed laser light as inspection light;
an inspection light guide optical system guiding the inspection light from the laser light source to the semiconductor device, and including scanning means that controls an optical path of the inspection light for two-dimensionally scanning by the inspection light within an inspection range set for the semiconductor device;
a solid immersion lens, disposed between the semiconductor device and the inspection light guide optical system, and condensing the inspection light while irradiating the semiconductor device with the inspection light from the inspection light guide optical system; and
electromagnetic wave detection means detecting an electromagnetic wave generated in the semiconductor device by irradiation of the inspection light, and emitted via the solid immersion lens,
wherein the semiconductor inspection method comprises:
an inspection range setting step of setting, for the semiconductor device, with reference to layout information thereof, the inspection range that needs to be two-dimensionally scanned by the inspection light via the solid immersion lens;
a position control step of controlling, with reference to the layout information of the semiconductor device, a position of the semiconductor device with respect to the inspection light guide optical system to arrange the inspection range at a predetermined position with respect to an optical axis; and
a scanning control step of controlling driving of the scanning means to control two-dimensional scanning by the inspection light via the solid immersion lens within the inspection range of the semiconductor device.

11. The semiconductor inspection method according to claim 10, wherein the inspection range setting step derives the inspection range based on an inspection object part extracted from the layout information of the semiconductor device.

12. The semiconductor inspection method according to claim 10, comprising a failure analysis step of performing analysis on a failure of the semiconductor device based on a detection result of the electromagnetic wave by the electromagnetic wave detection means.

13. The semiconductor inspection method according to claim 12, wherein the failure analysis step applies a threshold to a detected intensity of the electromagnetic wave by the electromagnetic wave detection means, and depending on whether the detected intensity is within or outside of a non-defective intensity range set by the threshold, discriminates whether the semiconductor device is non-defective or defective.

14. The semiconductor inspection method according to claim 12, wherein the failure analysis step discriminates whether a wire disconnection exists in wiring included in the semiconductor device as a failure of the semiconductor device.

15. The semiconductor inspection method according to claim 14, comprising a disconnected point estimation step of estimating a disconnected point in wiring included in the semiconductor device based on the layout information of the semiconductor device and an analysis result in the failure analysis step.
